(19) United States
(12) Patent Application Publication
(10) Pub. No.: US 2014/0368875 A1
(43) Pub. Date: Dec. 18, 2014

(54) IMAGE-FORMING APPARATUS, CONTROL METHOD FOR IMAGE-FORMING APPARATUS, AND STORAGE MEDIUM

(71) Applicant: CANON KABUSHIKI KAISHA, Tokyo (JP)

(72) Inventor: Tomoya Sato, Kawasaki-shi (JP)

(21) Appl. No.: 14/302,311

(22) Filed: Jun. 11, 2014

(30) Foreign Application Priority Data
Jun. 14, 2013 (JP) 2013-125718

(51) Int. Cl. H04N 1/00

(52) U.S. Cl. CPC H04N 1/00381; H04N 1/00408; H04N 1/00278
USPC 358/1.15

(57) ABSTRACT

An image-forming apparatus having a touch panel displays a menu screen for allowing selection of a function to be used from a plurality of functions included in the image-forming apparatus. In a case where the menu screen includes a plurality of pages, a screen is switched from a currently displayed page to another page if a user operation for requesting a transition between the plurality of pages is detected. Information usable for limiting the transition of the plurality of pages included in the menu screen is set. The switch of the screen from a currently displayed page to another page is limited based on the set information.

### BACKGROUND OF THE INVENTION

1. Field of the Invention

The present generally relates to image forming and, more particularly, to an image-forming apparatus having a touch panel, a control method for an image-forming apparatus, and a storage medium.

2. Description of the Related Art

In recent years, image-forming apparatuses each having a touch panel have generally been used. Some of such image-forming apparatuses may be configured to accept a what-is-called gesture operation. A flick operation is an example of such a gesture operation. A flick operation refers to an operation with a quick finger flick tracing on a touch panel. For example, when a list of contents is displayed on a screen, a flick operation may be performed on the list to scroll the list. Because such gesture operations may be easy for a user to intuitively understand, they have increasingly been used widely.

On the other hand, recent multi-function image-forming apparatuses have a plurality of functions such as a copying function, a facsimile function, and a scanning function. Such image-forming apparatuses may display a list of icons corresponding to buttons, for example, representing functions available for selection to allow a user to select a desired function out of the list. A screen displayed to prompt a user to select a function provided by an image-forming apparatus will be called a menu screen. The menu screen is displayed when a specific button for invoking the menu screen is pressed or when the apparatus is activated.

Japanese Patent Laid-Open No. 2011-210009 discloses an image-forming apparatus including a plurality of functions (a copying function, a facsimile function, a scanning function and so on), wherein a menu screen displays a list of a plurality of icons for selection of any one of the plurality of functions. Japanese Patent Laid-Open No. 2011-210009 discloses that when one screen is not enough for displaying all icons, a flick operation may be performed to smoothly move an icon to another page for display. This allows a user to select and use a function from a plurality of functions included in the image-forming apparatus.

However, Japanese Patent Laid-Open No. 2011-210009 does not consider how functions to be available to a general user are limited among a plurality of functions included in the image-forming apparatus. In other words, in an image-forming apparatus configured to allow selection of a function by sequentially switching pages of a menu screen, the method for limiting partial functions of a plurality of functions included in the image-forming apparatus to be available has not been established.

### SUMMARY OF THE INVENTION

According to an aspect of the present disclosure, there is provided an image-forming apparatus having a touch panel, the apparatus including a display unit configured to display a menu screen for allowing selection of a function to be used from a plurality of functions included in the image-forming apparatus, a detecting unit configured to detect an input operation performed by a user on the touch panel, a display controller configured to, in a case where the menu screen includes a plurality of pages, switch a screen from a page currently displayed by the display unit to another page if the detecting unit detects an operation for requesting a transition between the plurality of pages, and a setting unit configured to set information usable for limiting the transition of the plurality of pages included in the menu screen, wherein the display control unit limits the switch of the screen from a page currently displayed by the display unit to another page based on the information set by the setting unit.

Further features of the present disclosure will become apparent from the following description of exemplary embodiments with reference to the attached drawings.

### BRIEF DESCRIPTION OF THE DRAWINGS

FIG. 1 illustrates a hardware configuration of an information processing apparatus according to an exemplary embodiment of the present disclosure.

FIG. 2 illustrates a software configuration of an information processing apparatus according to an exemplary embodiment of the present disclosure.

FIG. 3 illustrates layout pattern examples held in a layout holding unit according to a first exemplary embodiment.

FIG. 4 schematically illustrates function-selection-button information held in a function-selection-button information holding unit according to the first exemplary embodiment.

FIG. 5 illustrates an example of a page-transition-propriety setting screen to be displayed on a display unit of the information processing apparatus according to the first exemplary embodiment.

FIG. 6 illustrates a screen example for setting a layout and a button display order of a menu to be displayed on the display unit of the information processing apparatus according to the first exemplary embodiment.

FIGS. 7A, 7B and 7C illustrate examples of a menu screen to be displayed on the display unit of the information processing apparatus according to the first exemplary embodiment.

FIG. 8 is a flowchart describing operations to be performed by the information processing apparatus according to the first exemplary embodiment.

FIG. 9 illustrates an example of a page-transition-permission setting screen to be displayed on a display unit of an information processing apparatus according to a second exemplary embodiment.

FIG. 10 is a flowchart describing operations to be performed by the information processing apparatus according to the second exemplary embodiment.

### DESCRIPTION OF THE EMBODIMENTS

Various exemplary embodiments, features, and aspects of the present disclosure will be described in detail below with reference to drawings.

### First Exemplary Embodiment

### Hardware Configuration

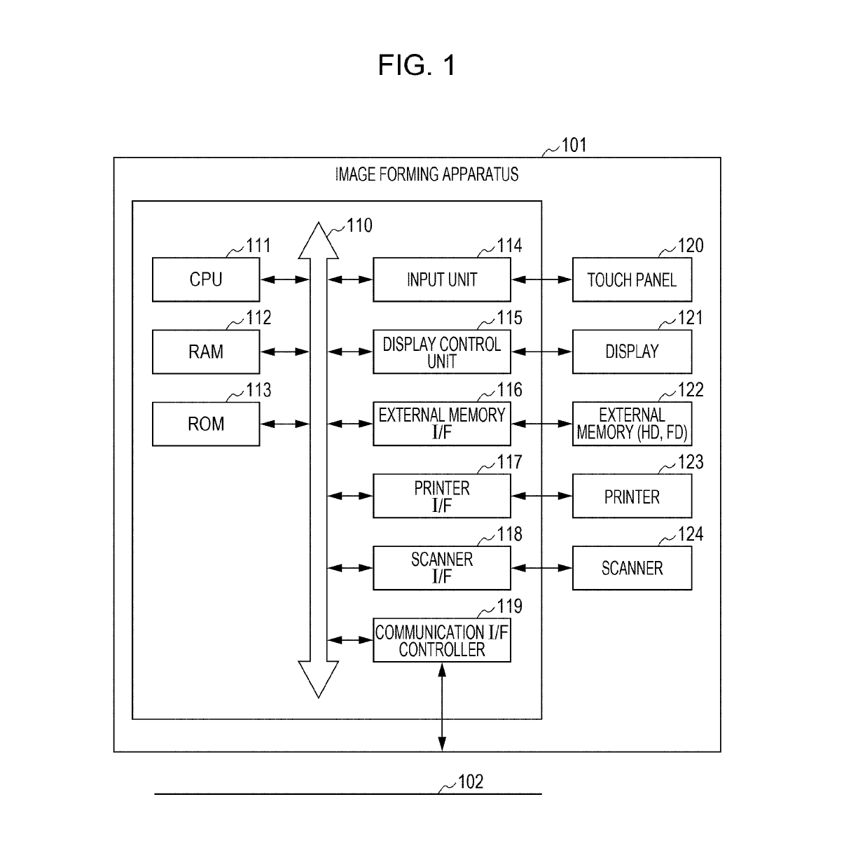

FIG. 1 illustrates a hardware configuration of an image-forming apparatus 101 according to an exemplary embodiment of the present disclosure.

A central processing unit (CPU) 111, a random access memory (RAM) 112, a read only memory (ROM) 113, an input unit 114, a display control unit 115, an external memory interface (hereinafter, called an I/F) 116, a printer I/F 117, a scanner I/F 118, and a communication I/F controller 119 are connected to a system bus 110. Further, a touch panel 120, a display device 121, an external memory 122, a printer 123, and a scanner 124 are connected thereto. The components connected to the system bus 110 are configured to be capable of exchanging data with each other via the system bus 110. As used herein, the term “unit” generally refers to any combination of software, firmware, hardware, or other component that is used to effectuate a purpose.

The ROM 113 is a non-volatile memory having areas predetermined for storing image data and other data and a program to be used by the CPU 111 for performing an operation. The RAM 112 is a volatile memory and is usable as temporarily storage areas such as a main memory and a work area for the CPU 111, for example. The CPU 111 may control components of the image-forming apparatus 101 by using the RAM 112 as a work memory in accordance with a program stored in the ROM 113, for example. A program to be used by the CPU 111 for performing an operation may be prestored in an external memory (such as a hard disk) 122 without limiting to being stored in the ROM 113.

The input unit 114 responsive to a user operation generates a control signal based on the operation and supplies it to the CPU 111. For example, the input unit 114 has a touch panel 120 as an input device for receiving a user operation. The touch panel 120 is further configured to output coordinates information based on a position of a point touched on its planer input unit, for example. The CPU 111 controls components of the image-forming apparatus 101 in accordance with a program based on a control signal generated and supplied by the input unit 114 in response to a user operation performed on the input device. This may cause the image-forming apparatus 101 to perform an operation based on a user operation.

The display control unit 115 outputs a display signal for displaying an image onto the display device 121. For example, a display control signal generated by the CPU 111 in accordance with a program is supplied to the display control unit 115. The display control unit 115 generates a display signal based on the display control signal and outputs it to the display device 121. For example, the display control unit 115 may cause the display device 121 to display a GUI screen included in a GUI (Graphical User Interface) based on a display control signal generated by the CPU 111.

The touch panel 120 is integrally provided in the display device 121. For example, the touch panel 120 configured to have a light transmittance that does not hinder display of the display device 121 may be mounted on an upper layer of a display surface of the display device 121. Coordinates input on the touch panel 120 are associated with display coordinates on the display device 121. This may provide a GUI configured as if a user is allowed to directly manipulate a screen displayed on the display device 121.

An external memory 122 such as a hard disk, a CD, a DVD, and a memory card may be mounted to the external memory I/F 116, for example. Under control of the CPU 111, data may be read out from the mounted external memory 122, and data may be written to the external memory 122.

A printer 123 is connected to the printer I/F 117. Under control of the CPU 111, image data to be printed by the printer 123 is transferred to the printer 123 via the printer I/F 117, and the printer 123 in turn prints the image data onto a recording medium and outputs it.

A scanner 124 is connected to the scanner I/F 118. Under control of the CPU 111, the scanner 124 reads an image on a document to generate image data. The generated image data is stored in the RAM 112, ROM 113 or the like via the scanner I/F 118.

Under control of the CPU 111, the communication I/F controller 119 implements wired, wireless or other communication over a network 102 such as a local area network (LAN) or the Internet. For example, image data generated by the scanner 124 may be externally transmitted through the network 102, or image data received externally through the network 102 may be printed by the printer 123.

The CPU 111 may detect the following operations and states performed on or of the touch panel 120, for example:

a state where a finger or a pen touches the touch panel (hereinafter, called a touch-down);

a state that the touch panel is being touched with a finger or a pen (hereinafter, called a touch on);

a state where a finger or a pen is being moved while being in contact with the touch panel (hereinafter called a move);

a state that a finger or pen having been in contact with the touch panel is released (hereinafter, called a touch-up); and

a state where nothing is in contact with the touch panel (hereinafter, called a touch off), for example.

It should be noted that the touch panel 120 may detect a multitouch. In other words, when the touch-down, touch-on, move, and/or touch-up are performed by a plurality of fingers and/or pens simultaneously, the touch panel 12 may detect the operations and states. Such an operation and coordinates of a position (position coordinates) touched with a finger or a pen on the touch panel are notified to the CPU 111 via the system bus 110, and the CPU 111 determines what kind of operation has been performed on the touch panel based on the notified information. With respect to a move, the direction of movement of a finger or a pen on the touch panel may also be determined for each vertical component and horizontal component on the touch panel based on a change of the position coordinates. Performing a touch-down and a touch-up through a move on the touch panel is referred as rendering a stroke. An operation for rendering a stroke quickly is referred as a flick. A flick refers to an operation for quickly moving a finger in contact with the touch panel for a certain distance and then releasing, that is, an operation with a quick finger flick for tracing on a touch panel. The CPU 111 determines that a flick has been performed when a move for a predetermined distance or longer and at a predetermined speed or higher is detected and a touch-up is detected directly after that. The CPU 111 determines that a drag has been performed when a move for a predetermined distance or longer is detected and a touch on is detected directly after that. When touch-downs with two fingers or pens are performed simultaneously on the touch panel and the position coordinates of the corresponding two points are moved in a mutually approaching direction, the CPU 111 determines that a pinch-in operation has been performed. When the position coordinates of the two points are moved in a mutually separating direction, the CPU 111 determines that a pinch-out operation has been performed. In some cases, a pinch-in operation and a pinch-out operation are collectively called a pinch operation.

The touch panel 120 may be any of a resistance film system, an electrostatic capacitance system, a surface acoustic wave system, an infrared ray system, an inductive coupling system, an image recognition system, a light sensor system and other various systems.

The image-forming apparatus 101 according to this exemplary embodiment may include a plurality of functions such as a printing function, a scanning function, and a copying function.

### Software Configuration

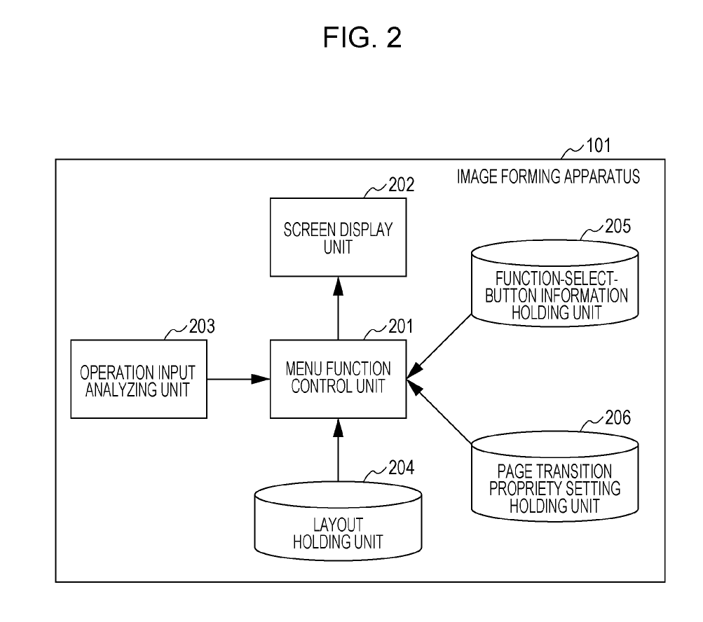

FIG. 2 illustrates a software configuration of the image-forming apparatus 101. Each software module within the image-forming apparatus 101 illustrated in FIG. 2 may be implemented by executing by the CPU 111 a control program stored in the ROM 113 or external memory 122.

The image-forming apparatus 101 has software modules including a menu function control unit 201, a screen display unit 202, an operation input analyzing unit 203, a layout holding unit 204, a function-selection-button information holding unit 205, and a page-transition-propriety setting holding unit 206.

The menu function control unit 201 performs processing for generating a menu screen. More specifically, the menu function control unit 201 performs processing for generating in the RAM 112 data on a menu screen to be displayed on the display device 121. The menu function control unit 201 may further perform processing for changing a layout of a menu screen in response to an event notified from the operation input analyzing unit 203 and switches the screen based on a function selected by a user on a menu screen. Details of the processing performed by the menu function control unit 201 will be described below. The term “menu screen” here refers to a screen to be displayed such that a function to be used is selectable by a user from a plurality of functions included in an image-forming apparatus.

The screen display unit 202 controls the display control unit 115 to display data generated by the menu function control unit 201 on the display device 121. The operation input analyzing unit 203 analyzes a control signal supplied from the input unit 114 and notifies an event based on a user operation to the menu function control unit 201.

The layout holding unit 204 holds information on a plurality of layout patterns of a menu screen and a currently selected layout pattern. The term “layout pattern” here refers to information regarding arrangement of function selection buttons to be displayed on a menu screen, including information on the number of function selection buttons to be displayed on one page and the size or sizes of the function selection buttons. The layout holding unit 204 holds all layout patterns selectable as menu functions of the image-forming apparatus 101, and each of the layout patterns has a defined layout pattern index uniquely indicative of the corresponding layout.

The function-selection-button information holding unit 205 holds information on a function selection button to be provided on a menu screen.

The page-transition-propriety setting holding unit 206 holds page-transition-propriety setting information describing whether transition between pages is permitted or not based on a user operation in a case where a menu screen has a plurality of screens (pages).

The information pieces held in the layout holding unit 204, function-selection-button information holding unit 205 and page-transition-propriety setting holding unit 206 is stored in the external memory 122. The information pieces are read out from the external memory 122 for use in processing for generating a menu screen or a menu setting screen by the menu function control unit 201.

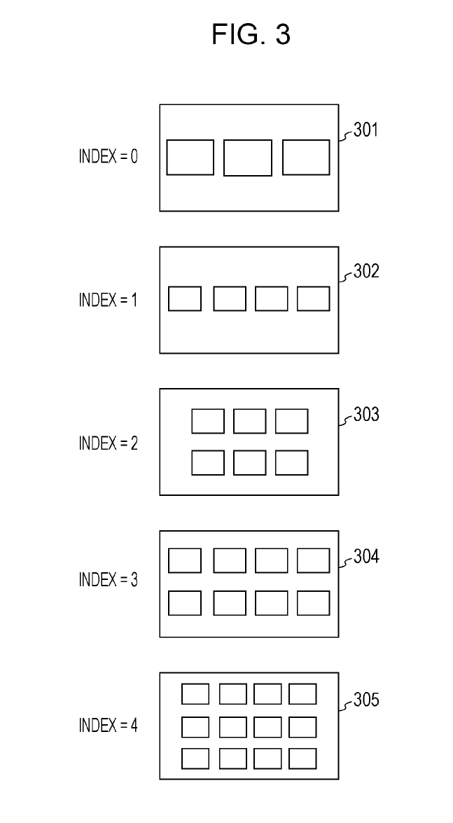

FIG. 3 schematically illustrates layout patterns held in the layout holding unit 204 and to be read out by the menu function control unit 201. FIG. 3 illustrates layout patterns 301 to 305. A plurality of boxes within each of the illustrated layout patterns represent function selection buttons arranged on a menu screen.

The layout pattern 301 has three function selection buttons to be displayed on one screen in a case where the display size of function selection button is “large”. Similarly, the layout patterns 302, 303, and 304 have four, six and eight function selection buttons, respectively, to be displayed on one screen in a case where the display size of function selection button is “medium”. The layout pattern 305 has 12 function selection buttons in a case where the display size of function selection button is “small”. The layout patterns 301 to 305 have settings of index 0 to index 4, respectively. The layout holding unit holds one of the plurality of layout patterns as a currently set layout pattern. The menu function control unit 201 reads out the currently set layout pattern from the layout holding unit 204 and arranges function selection buttons based on the read layout pattern to generate a menu screen.

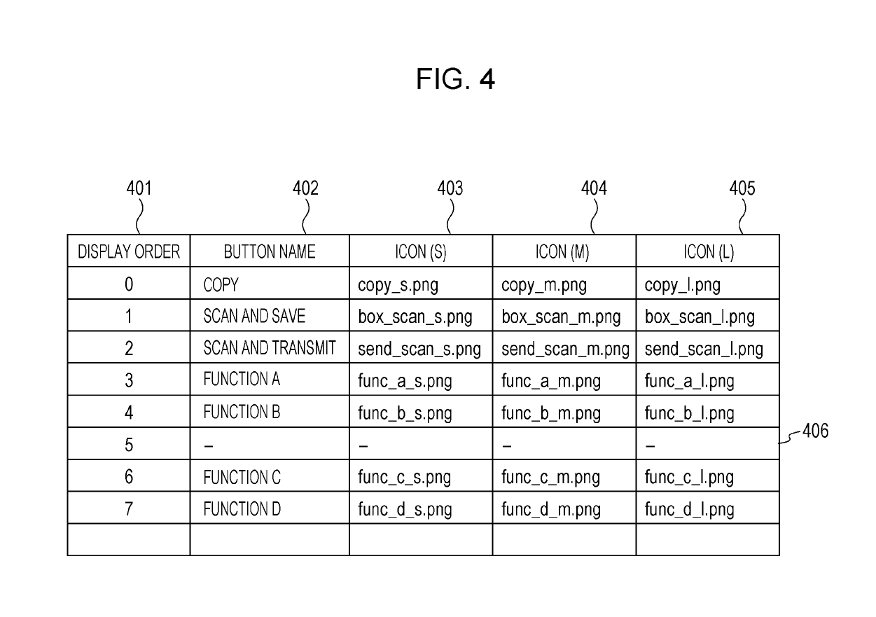

FIG. 4 schematically illustrates function-selection-button information held in the function-selection-button information holding unit 205 and to be read out by the menu function control unit 201. The function-selection-button information contains information pieces on a display order 401, a button name 402, and icons (403, 404, 405) for each function selection button to be arranged on a menu screen. The button name 402 is a character string to be displayed over a function selection button, and the icons (403, 404, 405) are icons one of which is to be displayed over a function selection buttons. The icons hold sizes of S, M, and L, and one of the icons may be used based on a layout pattern. These information pieces are notified from an application program upon activation or installation of the application program to run on the image-forming apparatus 101 and are held in the function-selection-button information holding unit 205. The display order 401 is the order of displaying the function selection buttons. The menu function control unit 201 arranges the function selection button in the order based on a layout pattern to generate a menu screen.

In a case where all function selection buttons may not be displayed on onscreen (page), the function selection buttons that are not covered by the screen are arranged on the next screen (page) in the order. For example, in a case where a layout (302) with index=1 of the layout pattern illustrated in FIG. 3 is currently set, the function selection button with display orders 0 to 3 are arranged in order on first page of a menu screen. In response to an operation for changing the page in the menu screen, the display is switched to the second page on which function selection buttons with display orders 4 to 7 are arranged. It should be noted that the display switch is performed smoothly by moving function selection buttons with display orders 4 to 7 arranged on the second page from the right side of the screen substantially simultaneously with movement to the left side of and disappearance from a screen having the function selection buttons with display orders 0 to 3 arranged on the first page. This provides a display as if a plurality of pages are virtually present in the right and left directions of the currently displayed page and those pages are sequentially switched.

In some cases, the function-selection-button information may include a row describing that no function selection buttons are to be displayed (406). In this case, the menu function control unit 201 does not arrange a function selection button in the part and leaves the corresponding area within a menu screen blank.

Though FIG. 4 illustrates eight function selection buttons including a blank, the number of function selection buttons may vary as required. For example, there may be a function (application) that is not usable at default and becomes usable in response to a license issuance. Such a function selection button for selecting a function may be added to the function-selection-button information in response to a license issuance.

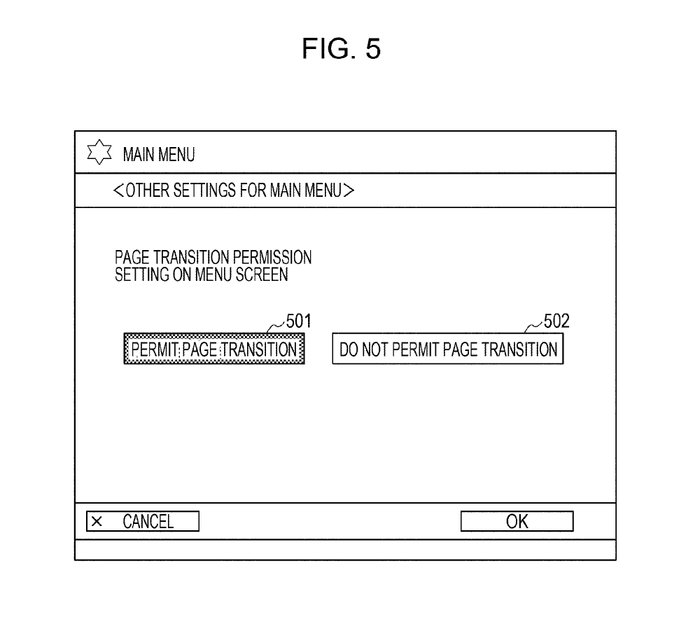

FIG. 5 illustrates an example of a screen for setting page-transition propriety to be displayed on the display device 121 in the setting image-forming apparatus 101. The screen in FIG. 5 may be generated by the menu function control unit 201 and be displayed on the display device 121 by the screen display unit 202.

A button 501 is selected for permitting page transition of a menu screen, and a button 502 is selected for not permitting page transition. The button 501 and the button 502 are controlled to switch a selected state between them exclusively. An administrator user of the image-forming apparatus 101 may invoke the screen as illustrated in FIG. 5 and set the page transition proprietary as necessity arises. The information set by the administrator user is held in the page-transition-propriety setting holding unit 206. In order to invoke the screen in FIG. 5, input of an administrator password is required for control to inhibit a general user excluding an administrator from changing the page-transition-propriety setting.

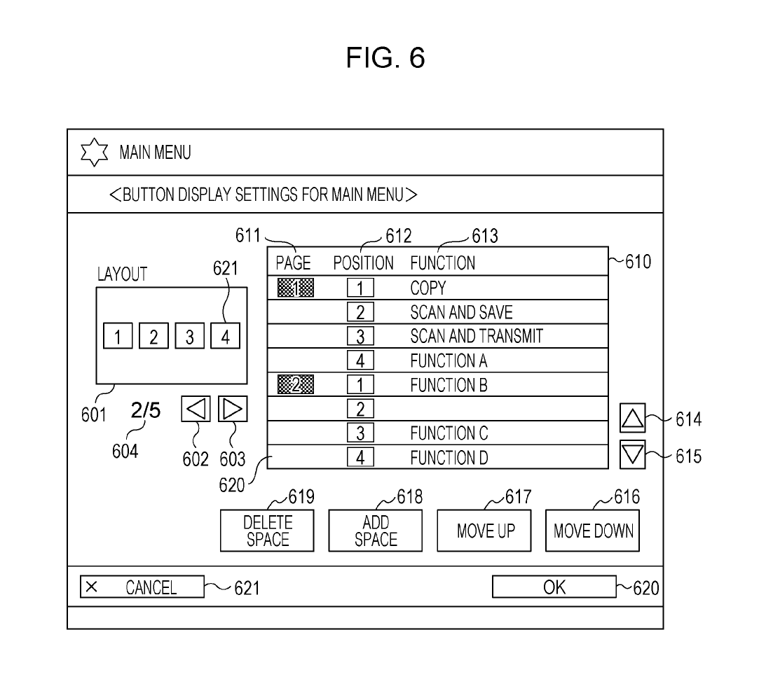

FIG. 6 illustrates an example of a screen for setting a display content on a menu screen. The screen in FIG. 6 is generated by the menu function control unit 201 and is displayed on the display device 121 by the screen display unit 202.

An area 601 displays a selected layout pattern. FIG. 6 illustrates a state example in which a layout (302) with layout pattern index=1 illustrated in FIG. 3 is selected. Buttons 602 and 603 are buttons for changing the layout to be displayed. In response to a press of the button 602 or the button 603, a layout pattern having a sequentially increased/reduced layout pattern index is read out from the layout holding unit 204, and an image having the corresponding layout is displayed on the area 601. An area 604 displays the number of selectable layout patterns and a currently selected layout pattern. In the illustrated example, five types of layout pattern are prepared, as illustrated in FIG. 3, and the second layout pattern (index=1) is currently selected. The administrator user may operate the button 602 and button 603 to select and set a desired layout from the prepared layout patterns.

An area 610 displays the display order of function selection buttons. The area 610 displays a list having columns including a page number 611, a display position 612, and a function selection button name 613. The page number 611 and display position 612 indicate that the function selection button in a given row is displayed as an Mth button on an Nth page (where M and N are integers). The displays of the page number 611 and display position 612 are changed in accordance with the currently selected layout pattern. FIG. 6 illustrates a state where a layout (302) with index=1 is selected. In other words, FIG. 6 illustrates a case where the number of function selection buttons to be displayed on one page is four. For example, because a row 620 allocated with a function selection button name “function D” has a page number “2” and a display position “4”, the button is allocated to the fourth button (position 621) on the second page for display.

The menu function control unit 201 reads out function-selection-button information held in the function-selection-button information holding unit 205 and displays the corresponding list in the area 610 based on the display order. Buttons 614 and 615 are usable for scrolling the list 610. In a case where the function selection buttons contained in function-selection-button information do not fit into the list 610, the button 614 and button 615 may be pressed to display the preceding and subsequent rows of the currently displayed list. Rows in the area 610 are available for selection, and when any one of the rows is touched by a user, it enters to a selected state. When another row is touched, the newly touched row enters to a selected state. The selected state of the row touched previously is cancelled.

Buttons 616 and 617 are a button usable for changing the display order. When any one of rows in the area 610 is selected and the button 616 is then pressed, the function selection button of the row having the selected state is interchanged with the one lower function selection button for display. Similarly, when the button 617 is pressed, the function selection button of the row having the selected state is interchanged with the one upper function selection button for display.

Buttons 618 and 619 are usable for adding and deleting a blank, respectively. When any one of rows in the area 610 is selected and the button 618 is then pressed, a blank is inserted to the row having the selected state, and rows after the inserted blank are displayed from one lower position. When a blank row is selected and the button 619 is then pressed, the blank is deleted, and the subsequent rows are displayed from the one upper position. The blank is arranged to leave an area blank within a menu screen without placing a function selection button in the area.

A button 620 is an OK button which is used for confirming a defined setting. When the button 620 is pressed, information pieces on the defined layout pattern and display order of function selection buttons are held in the layout holding unit 204 and function-selection-button information holding unit 205, respectively, and the original screen is displayed again. A button 621 is a cancel button for returning the original screen without changing settings. In order to invoke the screen illustrated in FIG. 6, the input of an administrator password is required to control to inhibit a general user excluding the administrator from changing the page-transition-propriety setting.

The layout or display order of function selection buttons may be changed by a different manner. For example, a pinch operation performed on a menu screen may be detected to change the layout pattern. Performing an operation for dragging and dropping a function selection button after detection of a long press on a menu screen may allow change of the display order of function selection buttons. Even when those changes are implemented by a different manner, it is controlled to permit an administrator exclusively to perform the layout changing operation and the operation for changing the display of operation function selection buttons.

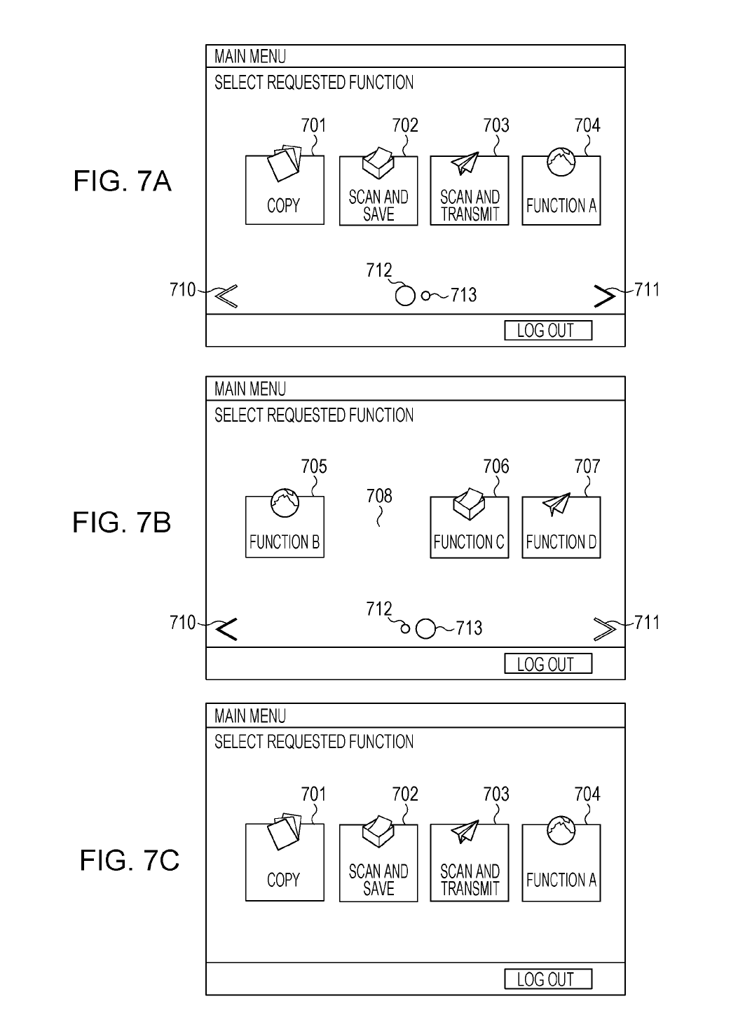

FIGS. 7A to 7C illustrate menu screen examples generated by the menu function control unit 201 and displayed on the display device 121 by the screen display unit 202. FIGS. 7A to 7C assume a case where the layout pattern and display order of function selection buttons are set as illustrated in FIG. 6.

FIGS. 7A and 7B illustrate a screen example where the page-transition-propriety setting is set to permit page transition (hereinafter, which will be called transition-permitted), and FIG. 7C illustrates a screen example where the page-transition-propriety setting is set to not to permit page transition (which will be called “transition-not-permitted” below). When a menu screen is invoked with the transition-permitted setting, the screen as illustrated in FIG. 7A is displayed first. FIG. 7A illustrates function selection buttons 701 to 704. The button names 402 and icons 404 illustrated in FIG. 4 are displayed over the buttons. When a press on any one of the buttons is detected from an event notified from the operation input analyzing unit 203, the displayed screen is switched to a screen for providing the corresponding function.

FIGS. 7A and 7B illustrate page indicators 712 and 713. Each page is schematically indicated by a circle, and the circles represent a plurality of pages aligned in a virtually right-to left direction. A page indicator 712 in FIG. 7A among page indicators indicate the currently displayed page and is represented by a larger circle than circles of indicators for other pages (such as the indicator 713 in FIG. 7A). In the screen example, because two page indicators (712, 713) are displayed, a total of two menu pages exist. FIG. 7A illustrates a screen of the first page in which the currently displayed page is arranged virtually at the most left position. While different sizes of page indicators are used to indicate the currently displayed page, how it is indicated is not limited thereto. For example, indicators having different colors/shapes may be used to indicate the currently displayed page.

FIGS. 7A and 7B illustrate page transition buttons 710 and 711. The page transition button 710 is usable for instructing transition to a page placed on the left side of the page that is virtually currently displayed. The page transition button 711 is usable for instructing transition to a page placed on the virtually right side. The page transition buttons 710 and/or 711 are gray-out displayed to indicate that they are invalid in a case where no pages exist on the left and/or right sides, respectively, of the currently displayed page. For example, referring to FIG. 7A, the button 710 is gray-out displayed because no page exists on the left of the currently displayed page.

When a press of the button 711 or a flick operation performed in the right-to-left direction on the screen illustrated in FIG. 7A is detected, the screen switches to the screen illustrated in FIG. 7B. Referring to FIG. 7B, function selection buttons 705 to 707 are displayed. Referring to FIG. 7B, the size of the page indicator 712 is changed to a normal size, and the size of the circle of the page indicator 713 is increased. Consequently, the page (second page) on the right side is displayed. The button 711 is changed to be gray-out displayed and becomes invalid, and the button 710 becomes valid. When a press of the button 710 or a flick operation in the left to right direction is detected on the screen illustrated in FIG. 7B, the screen illustrated in FIG. 7A is displayed again. The area 708 for displaying a function selection button is displayed as a blank because the display order 5 in the function-selection-button information illustrated in FIG. 4 describes that no buttons are to be displayed there (406).

The screen example in FIGS. 7A to 7C shows a layout example in which the number of function selection buttons to be displayed on one screen is equal to four and the total number of function selection buttons to be displayed on a menu screen is equal to eight including a blank. Therefore, a menu including two screens (two pages) as illustrated in FIGS. 7A and 7B may be provided. In some layout patterns and with some total number of function selection buttons, more screens (pages) may be displayed and may be switched for display. It may also involve changing the display forms of the page indicators.

FIG. 7C illustrates a screen example provided in a case where the page-transition-propriety setting is set to the transition-not-permitted. In this case, the page transition buttons 710 and 711 and page indicators 712 and 713 are not displayed. On the screen illustrated in FIG. 7C, no page transition is performed even when a flick operation is detected. Thus, a user is only allowed to use the function selection buttons 701 to 704 displayed on the screen illustrated in FIG. 7C, and the function selection buttons 705 to 707 are not available.

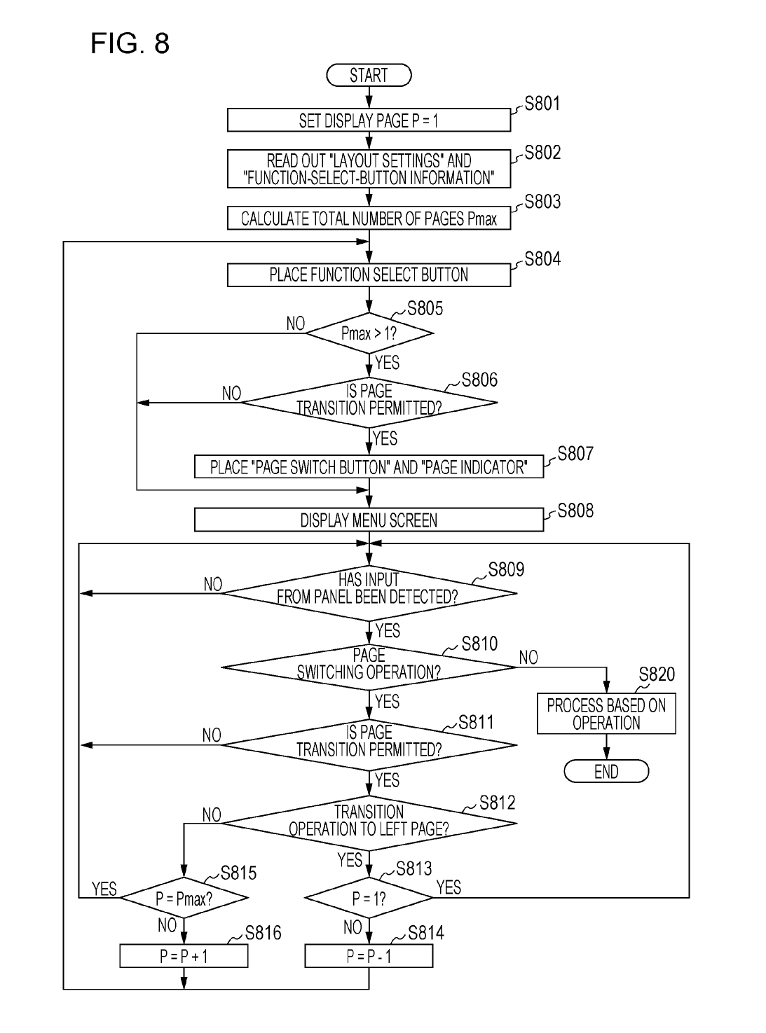

Next, with reference to FIG. 8, operations to be performed by the image-forming apparatus 101 according to this exemplary embodiment will be described. FIG. 8 is a flowchart illustrating operations to be performed for displaying operation screens as illustrated in FIGS. 7A to 7C on the display device 121 in the image-forming apparatus 101 of this exemplary embodiment. Steps illustrated in FIG. 8 are processed by the CPU 111 by executing a program stored in the ROM 113 or the external memory 122. The processing is called when a press of a dedicated button (not illustrated) for invoking a menu screen is detected or when no input to the input unit 114 is detected for a predetermined period of time.

First, in step S801, the CPU 111 sets the currently displayed page number P to 1. According to this exemplary embodiment, menu pages appear to be virtually horizontally arranged in line, and page numbers 1, 2, 3 and so on are arranged in order from the most left page. Next, in step S802, the CPU 111 reads out the current-layout-setting information and function-selection-button information. More specifically, the menu function control unit 201 reads out information of a layout pattern from the layout holding unit 204 and reads out function-selection-button information from the function-selection-button information holding unit 205. Next, in step S803, the CPU 111 calculates a total number of pages Pmax. More specifically, the menu function control unit 201 calculates a number of pages required for displaying function selection buttons by dividing a total number of buttons including a blank button acquired from the function-selection-button information by the number of function selection buttons that may be displayed on one page of the current layout pattern. The calculated value is handled as the Pmax. For example, from the function-selection-button information in FIG. 4, the total number of buttons including the blank button is equal to 8. When the current layout pattern has a layout index=1, the number of function selection button displayable on one page is equal to 4. This results in Pmax=8/4=2.

Next in step S804, the CPU 111 arranges the function selection buttons based on the read layout pattern to generate a menu screen. More specifically, the menu function control unit 201 arranges the function selection buttons in the set display order based on the layout to generate a screen for the Pth page on the RAM 112. In this case, P is the current display page number. Next in step S805, the CPU 111 determines whether the menu screen has a plurality of pages or not. More specifically, the menu function control unit 201 determines whether the Pmax calculated in step S803 is higher than 1 or not. If the calculated number of pages is equal to or higher than 2, the processing moves to step S806. If the calculated number of pages is equal to 1, the processing moves to step S808.

In step S806, the CPU 111 determines whether page transition is permitted or not. More specifically, the menu function control unit 201 reads out page transition setting information from the page-transition-propriety setting holding unit 206, and when the menu function control unit 201 determines that transition-permitted is set, the processing moves to step S807. If it is determined that the transition-not-permitted is set, the processing moves to step S808. In step S807, the CPU 111 arranges “page transition buttons” and “page indicators” in addition to an image generated on the RAM 112. Exemplarily, the page transition buttons may correspond to the buttons 710 and 711 in FIGS. 7A and 7B, and the page indicators may correspond to the indicators 712, 713 illustrated in FIGS. 7A and 7B. More specifically, the menu function control unit 201 arranges page indicators based on the number of pages Pmax calculated in step S803, the Pth page indicator may be highlighted by which the currently displayed page is identifiable. The menu function control unit 201 further generates on the RAM 112 a screen in which images of page transition buttons are added and arranged. In this case, if P=1, the left page transition button (710) is gray-out displayed as invalid. If P=Pmax, the right page transition button (711) is gray-out displayed as invalid.

Next, in step S808, the CPU 111 displays the menu screen. More specifically, the screen display unit 202 controls the display control unit 115 to display the screen data generated on the RAM 112 onto the display device 121. The processing in step S807 results in the screen as illustrated in FIG. 7A or 7B displayed on the display device 121 through the processing described above. On the other hand, when the processing in step S807 is not performed, that is, the menu screen includes one page only, or when the menu screen includes a plurality of pages but the transition-not-permitted is set, a screen as illustrated in FIG. 7C is displayed.

Next in step S809, the CPU 111 determines whether any input has been received from the touch panel 120 or not. More specifically, the operation input analyzing unit 203 determines whether any input signal has been received from the touch panel 120 through the input unit 114 or not. If so in step S809, the processing moves to step S810. In step S810, the CPU 111 determines whether the detected operation input is a page transition operation or not. More specifically, the operation input analyzing unit 203 analyzes touched position coordinates and its change based on a signal input from the touch panel 120 to identify the type of input operation. When the identified operation is a press of the page transition button (710, 711) or is a flick operation in the right-to-left direction, the operation is determined as a page transition operation, and the processing moves to step S811. In step S811, the CPU 111 determines whether transition-permitted is set or not. More specifically, the menu function control unit 201 reads out the page-transition-propriety setting information from the page-transition-propriety setting holding unit 206 for the determination. If it is determined that transition-permitted is set, the processing moves to step S812. On the other hand, if it is determined that transition-permitted is not set, the processing returns to step S809 where a next input is awaited. In other words, when page transition is not permitted, a flick operation in the right-to-left direction is invalid.

In step S812, the CPU 111 determines whether the input operation is a transition operation to a left page or not. More specifically, when the operation type identified by the operation input analyzing unit 203 is a press operation on the page transition button 710 or a flick operation in the right direction, it is determined as a transition operation to a left page, the processing moves to step S813. In step S813, the CPU 111 determines whether any left page exists or not. More specifically, the menu function control unit 201 determines whether P=1 or not. If P=1, it means that the currently displayed page is at the left end and that no further transition to a left page is possible. Therefore, the processing returns to step S809 without performing page transition, and a next input is awaited. If a left page exists, the processing moves to step S814. In step S814, the CPU 111 subtracts 1 from the value of P, and the processing returns to step S804. Performing processing in step S804 and subsequent steps results in display of the left page shifted in the menu screen. In step S812, if it is determined that the operation is not a transition operation to a left page or if it is a transition operation to a right page, the processing moves to step S815. In step S815, the CPU 111 determines whether any right page exists or not. More specifically, the menu function control unit 201 determines whether P=Pmax or not. If P=Pmax, it means that that the currently displayed page is at the right end and that no further transition to a right page is possible. Therefore, the processing returns to step S809 without performing page transition, and a next input is awaited. If a right page exists, the processing moves to step S816. In step S816, the CPU 111 adds 1 to the value of P, and the processing returns to step S804. Performing processing in step S804 and subsequent steps results in display of the right page shifted in the menu screen.

If it is determined in step S810 that the detected operation is not a page transition operation, the processing moves to step S820. In step S820, the CPU 111 performs processing corresponding to the input operation. For example, for an operation for pressing a function selection button on the menu screen, the menu function control unit 201 performs processing for switching to a screen for executing the selected function.

As described above, when a next page is displayed after the processing in step S814 and step S816 is performed, the screen is displayed as if the function selection buttons arranged on the current page are moving and disappearing from the screen. Substantially at the same time as the movement and disappearance from the screen of the function selection buttons, the screen is switched as if function selection buttons arranged on the next page are moving from outside of the screen and entering to the screen smoothly. This may provide appearance as if a plurality of page virtually exist in the right-to-left direction of the currently displayed page and the page is sequentially being switched. When it is determined in step S813 or step S815 that a transition operation is performed though the currently displayed page is an end page and further page transition is not possible, a notification by which a user may identify that further page transition is not possible may be displayed. For example, function selection buttons may be transformed, or the entire screen or page indicators may be displayed in different colors.

A menu screen may only be subject to control over transition propriety between pages based on a page-transition-propriety setting. For example, the image-forming apparatus 101 may provide a preview display of image data generated by the scanner 124 on the display device 121. When the image data contains a plurality of pages, a page transition based on a flick operation may be possible. Such preview display of image data may be controlled to allow a page transition even when the page-transition-propriety setting is set to the transition-not-permitted.

In the image-forming apparatus 101 of this exemplary embodiment, when the page transition-permitted is set, transition between a plurality of pages included in a menu screen is permitted for display in response to a flick operation or a page-transition-button pressing operation. Thus, a user is allowed to display and select an arbitrary function selection button and cause processing based on the selection to be executed. On the other hand, when the page-transition-not-permitted is set, page transition is not permitted. Thus, a user is permitted to press a function selection button displayed on the first page only and is not permitted to press the other function selection buttons. Therefore, by correctly setting the page transition proprietary, layout and button display order on the setting screen as illustrated in FIG. 5 and FIG. 6, an administrator user of the image-forming apparatus 101 may easily limit functions to be available to a general user.

### Second Exemplary Embodiment

Next, a second exemplary embodiment will be described. According to the first exemplary embodiment, whether page transition is to be permitted or not is allowed to be set. According to the second exemplary embodiment on the other hand, the number of pages subject to page transition is allowed to be set. The second exemplary embodiment will be described below with focus on differences from the first exemplary embodiment.

According to the first exemplary embodiment, the page-transition-propriety setting information held in the page-transition-propriety setting holding unit 206 describes a setting regarding whether page transition is permitted or not. On the other hand, according to the second exemplary embodiment, the page-transition-propriety setting holding unit 206 may hold information describing the last page permitted for the transition.

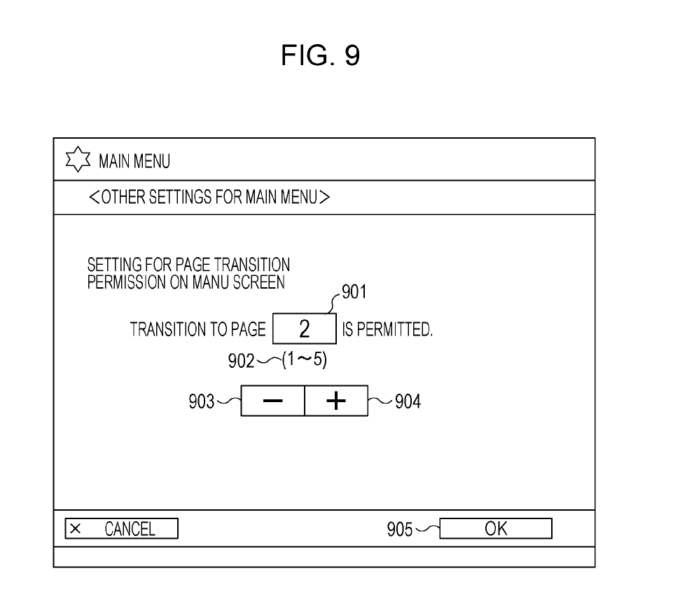

FIG. 9 illustrates a screen example on which a page-transition-propriety setting is defined according to the second exemplary embodiment of the present disclosure. According to the second exemplary embodiment, the menu function control unit 201 generates a screen as illustrated in FIG. 9, instead of the screen as illustrated in FIG. 5 according to the first exemplary embodiment, and the screen display unit 202 displays it on the display device 121. A value 901 indicates a currently set last page number permitted for transition. For example, when a value “2” is set, it is controlled such that transition between the first page and the second page is permitted while transition to other pages is not permitted. An area 902 provides a settable range. A minus button 903 and a plus button 904 are usable for respectively increasing and reducing the set value. When the minus button 903 is pressed, the value 901 is reduced by 1. When the plus button 904 is pressed, the value 901 is increased by 1. When an OK button 905 is pressed, the set value 901 is held in the page-transition-propriety setting holding unit 206, and the screen illustrated in FIG. 9 is closed. An administrator user may invoke the screen in FIG. 9 as necessity arises to set the page number where the permitted page transition ends. Similarly to the screen in FIG. 5, in order to invoke the screen as illustrated in FIG. 9, input of an administrator password is required for control to inhibit a general user excluding an administrator from changing the page-transition-propriety setting.

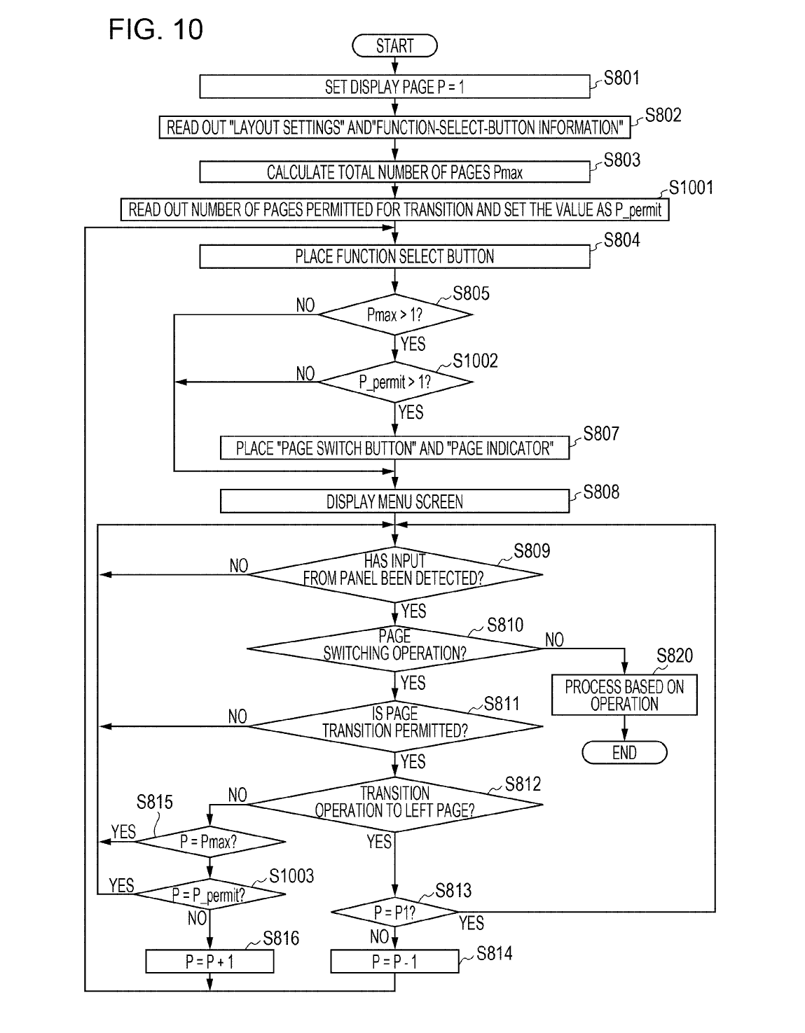

Next, with reference to FIG. 10, operations to be performed by the image-forming apparatus 101 according to second exemplary embodiment will be described. Steps illustrated in FIG. 10 are processed by the CPU 111 by executing a program stored in the ROM 113 or external memory 122. Like numbers refer to like steps as those with like numbers illustrated in FIG. 8 according to the first exemplary embodiment, and the description will be omitted.

Processing in steps S801 to S803 is the same as the processing according to the first exemplary embodiment. After step S803, the processing moves to step S1001. In step S1001, the CPU 111 reads out the number of pages permitted for page transition. More specifically, the menu function control unit 201 reads out the number of pages permitted for transition from the page-transition-propriety setting holding unit 206 and holds the value of the number of pages permitted for transition as P_permit. Processing in steps S804 and S805 is the same as the processing in the corresponding steps according to the first exemplary embodiment. If it is determined in step S805 that Pmax is higher than 1, the processing moves to step S1002. In step S1002, the CPU 111 determines whether the number of pages permitted for transition is higher than 1 or not. More specifically, the menu function control unit 201 determines whether P_permit read out in step S1001 is equal to or higher than 1 or not. If P_permit is equal to 1, it means that transition to other pages than the page (P=1) displayed first is not permitted. In this case, the processing moves to step S808. If P_permit is higher than 1, the processing moves to step S807. In step S807, the CPU 111 arranges “page transition buttons” and “page indicators” in addition to an image generated on the RAM 112, like the first exemplary embodiment. An equal number of page indicators to the number of the pages (P_permit) permitted for transition are provided according to the second exemplary embodiment while an equal number of page indicators to the number of all pages that exist (Pmax) is provided according to the first exemplary embodiment. The processing from step S808 to step S815 is the same as the processing in the corresponding steps according to the first exemplary embodiment. If no in step S815, the processing moves to step S1003. In step S1003, the CPU 111 determines whether a maximum number of pages permitted for transition are being displayed or not. More specifically, the menu function control unit 201 determines whether the relationship P=P_permit is satisfied or not. If the relationship P=P_permit is satisfied, it means that currently displayed page is the last page of the maximum number of pages permitted for transition. Therefore, further transition to the right page is inhibited. Consequently, the processing returns to step S809 without performing page transition where a next input is awaited. If it is determined that the transition has not reached the last page of the maximum number of pages permitted for transition, the processing moves to step S816. The subsequent processing is the same as that of the first exemplary embodiment.

While the last page permitted for transition is directly set on the screen as illustrated in FIG. 9, the method is not limited thereto. For example, selection of an arbitrary function selection button may be allowed on a screen for setting display order of function selection buttons as illustrated in FIG. 6, and it may be controlled such that transition up to the selected button may be permitted. In this case, the value P_permit may be calculated from the currently selected layout pattern and the display order of the selected function selection button.

Having described an example in which the last page of pages permitted for transition is set on the screen illustrated in FIG. 9, setting the range of pages permitted for transition may be allowed. For example, when a menu screen includes 5 pages, it may be set such that page transition from the second page to the fourth page may be permitted and page transition at the first page and fifth page may not be permitted.

The image-forming apparatus 101 according to this exemplary embodiment allows setting of the range of pages permitted for transition to control such that transition is permitted up to a specific page and further page transition is inhibited. Therefore, an administrator user of the image-forming apparatus 101 may more flexibly control functions available to a general user by correctly setting the transition permitted pages, layout and button display order on the setting screen as illustrated in FIGS. 6 and 9.

### Other Exemplary Embodiments

Having described exemplary embodiments of the present disclosure in detail, the present disclosure is not limited to the specific exemplary embodiments, various aspects without departing from the scope and spirit of the present disclosure are also included in the present disclosure. The aforementioned exemplary embodiments may be partially combined as desired.

Having described according to the exemplary embodiments that transition to the page with the setting of transition-not-permitted is not permitted, for example, whether page transition is permitted or not may be changed in accordance with the type of user who logs in the image-forming apparatus 101. For example, when a general user logs in, the control as described with reference to FIGS. 8 and 10 may be performed. When an administrator user logs in, transition between all pages included in a menu screen may be permitted regardless of the information held in the page-transition-propriety setting holding unit 206.

While transition between a plurality of pages included in a menu screen is performed in response to a flick operation or a page-transition-button pressing operation according to the aforementioned exemplary embodiments, such transition may be performed in response to a drag operation.

As described above, according to the aforementioned exemplary embodiments, when a menu screen that is a specific screen which prompting a user to select a function to be used from a plurality of functions included in an image-forming apparatus includes a plurality of pages, the page to be displayed may be switched in response to an operation input by a user. Setting page-transition-propriety setting information that is information for limiting transition between a plurality of pages included in such a menu screen may limit switch of the page to be displayed. Thus, a function to be available to a general user may be limited among a plurality of functions. Furthermore, a function to be available to a general user may be flexibly limited by correctly setting a page layout and display order of function selection buttons.

Having described the image-forming apparatus 101 having a plurality of functions such as a copying function and a scanning function, for example, according to the exemplary embodiment, the present disclosure is applicable to an image processing apparatus having a part of the functions. Furthermore, the present disclosure is applicable to other information processing apparatuses such as a personal computer, a personal digital assistant (PDA), a cellular phone, a facsimile (FAX), a camera, a video camera, and any variety of other image viewers.

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiments of the present disclosure, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, in an image-forming apparatus in which a plurality of pages included in a menu screen are switched and are displayed sequentially so that an arbitrary function of a plurality of functions is selectable, the switch of the pages to be displayed may easily be controlled.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2013-125718 filed Jun. 14, 2013, which is hereby incorporated by reference herein in its entirety.

What is claimed is:

1. An image-forming apparatus having a touch panel, the apparatus comprising:
a display unit configured to display a menu screen for allowing selection of a function to be used from a plurality of functions included in the image-forming apparatus;
a detecting unit configured to detect an input operation performed by a user on the touch panel;
a display control unit configured to, in a case where the menu screen includes a plurality of pages, switch a screen from a page currently displayed by the display unit to another page if the detecting unit detects an operation for requesting a transition between the plurality of pages; and
a setting unit configured to set information usable for limiting the transition of the plurality of pages included in the menu screen,
wherein the display control unit limits the switch of the screen from a page currently displayed by the display unit to another page based on the information set by the setting unit.

2. The image-forming apparatus according to claim 1, wherein the setting unit sets whether transition between the plurality of pages included in the menu screen is to be permitted or not.

3. The image-forming apparatus according to claim 1, wherein the setting unit sets limits to pages permitted for the transition among a plurality of pages included in the menu screen.

4. The image-forming apparatus according to claim 1, further comprising:
a first holding unit configured to hold a plurality of layout patterns that are information on arrangement of function selection buttons to be displayed on the menu screen;
a second holding unit configured to hold function-selection-button information including a display order of function selection buttons; and
a generating unit configured to generate the menu screen by arranging function selection buttons in a display order included in the function-selection-button information held in the second holding unit based on a layout pattern selected from the plurality of layout patterns held in the first holding unit.

5. The image-forming apparatus according to claim 4, wherein selection of a layout pattern to be used is allowed from a plurality of layout patterns held in the first holding unit through a setting screen usable for setting a display content for the menu screen, and a display order for function selection buttons included in the function-selection-button information held in the second holding unit is allowed to be set.

6. The image-forming apparatus according to claim 5, wherein a layout pattern held in the first holding unit includes a number of the function selection buttons to be displayed on one page of the menu screen and a size of the function selection buttons.

7. The image-forming apparatus according to claim 5, wherein the function-selection-button information held in the second holding unit includes a button name that is a character string to be displayed on a function selection button on the menu screen and an icon to be displayed on the function selection button.

8. The image-forming apparatus according to claim 1, wherein the display control unit displays or hides a page transition button for instructing transition from a page currently being displayed by the display unit to another page based on information set by the setting unit.

9. The image-forming apparatus according to claim 1, wherein information may be set by the setting unit exclusively under control of an administrator.

10. The image-forming apparatus according to claim 1, wherein an operation for requesting transition between the plurality of pages detected by the detecting unit includes a flick operation onto the touch panel.

11. A control method for an image-forming apparatus having a touch panel, the method comprising:
displaying a menu screen for allowing selection of a function to be used from a plurality of functions included in the image-forming apparatus;
detecting an input operation performed by a user on the touch panel;
display controlling, in a case where the menu screen includes a plurality of pages, by switching a screen from a page currently displayed by the displaying to another page if the detecting detects an operation for requesting a transition between the plurality of pages; and
setting information usable for limiting the transition of the plurality of pages included in the menu screen,
wherein the display controlling limits the switch of the screen from a page currently displayed by the displaying to another page based on the information set by the setting.

12. The control method according to claim 11, wherein the setting information sets whether transition between the plurality of pages included in the menu screen is to be permitted or not.

13. The control method according to claim 11, wherein the setting information sets limits to pages permitted for the transition among a plurality of pages included in the menu screen.

14. The control method according to claim 11, further comprising:
first holding for holding a plurality of layout patterns that are information on arrangement of function selection buttons to be displayed on the menu screen;
second holding for holding function-selection-button information including a display order of function selection buttons; and
generating for generating the menu screen by arranging function selection buttons in a display order included in the function-selection-button information held by the second holding based on a layout pattern selected from the plurality of layout patterns held by the first holding.

15. The control method according to claim 14, wherein selection of a layout pattern to be used is allowed from a plurality of layout patterns held in the first holding through a setting screen usable for setting a display content for the menu screen, and a display order for function selection buttons included in the function-selection-button information held by the second holding is allowed to be set.

16. The control method according to claim 15, wherein a layout pattern held by the first holding includes a number of the function selection buttons to be displayed on one page of the menu screen and a size of the function selection buttons.

17. The control method according to claim 15, wherein the function-selection-button information held by the second holding includes a button name that is a character string to be displayed on a function selection button on the menu screen and an icon to be displayed on the function selection button.

18. The control method according to claim 11, wherein the display controlling displays or hides a page transition button for instructing transition from a page currently being displayed by the display unit to another page based on information set by the setting information.

19. The control method according to claim 11, wherein information may be set by the setting information exclusively under control of an administrator.

20. The control method according to claim 11, wherein an operation for requesting transition between the plurality of pages detected by the detecting unit includes a flick operation onto the touch panel.

21. A computer-readable storage medium storing a computer program configured to cause a computer to implement a control method for an image-forming apparatus having a touch panel, the method comprising:
displaying a menu screen for allowing selection of a function to be used from a plurality of functions included in the image-forming apparatus;
detecting an input operation performed by a user on the touch panel;
display controlling, in a case where the menu screen includes a plurality of pages, by switching a screen from a page currently displayed by the displaying to another page if the detecting detects an operation for requesting a transition between the plurality of pages; and
setting information usable for limiting the transition of the plurality of pages included in the menu screen,
wherein the display controlling limits the switch of the screen from a page currently displayed by the displaying to another page based on the information set by the setting.
